(19) United States
(12) Patent Application Publication
(10) Pub. No.: US 2010/0007919 A1
(43) Pub. Date: Jan. 14, 2010

(54) DOCUMENT MANAGEMENT APPARATUS, DOCUMENT MANAGEMENT METHOD, AND DOCUMENT MANAGEMENT PROGRAM

(75) Inventor: Kouya Okabe, Tokyo (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/502,155

(22) Filed: Jul. 13, 2009

(30) Foreign Application Priority Data
Jul. 14, 2008 (JP) 2008-182905

(51) Int. Cl. G06F 3/12

(52) U.S. Cl. 358/1.15

(57) ABSTRACT

In a document management apparatus, a document search unit is configured to operate under the control of a main controller to search for document entities and objects from a document information storage unit via a document information operation unit and acquire document entities and objects found in the search operation. A degree-of-association calculator is configured to operate under the control of the main controller to calculate the degrees of association between objects for the objects stored in the document information storage unit and register the calculated degrees of association in a degree-of-association information storage unit via a degree-of-association information operation unit. A degree-of-association information search unit is configured to operate under the control of the main controller to search for degree-of-association information between objects from the degree-of-association information storage unit via the degree-of-association information operation unit and acquire the degree-of-association information found in the search operation.

### BACKGROUND OF THE INVENTION

1. Field of the Invention

The present invention relates to a document management system configured to present a content of a document according to a selection made by a user.

2. Description of the Related Art

In recent years, a technique has been proposed which allows a document to be reconstructed into a form easily understandable by users. For example, in a case where a technical document or manual with many pages such as several hundred pages is searched to find desired information, a common way for a user to find the information is to perform a keyword search based on an index.

However, there is a possibility that desired information is scattered across a plurality of locations in a document. Another possibility is that a user does not always think of a proper keyword to be used to get information. There is also a possibility that a user cannot find a proper keyword in an index.

In such a case, a user has to repeat the searching many times, and has to read all over parts around locations where a keyword is hit, which is troublesome for the user.

To solve the above problem, Japanese Patent Laid-Open No. 11-272666 discloses a document editing system configured to extract blocks (elements or parts) from a plurality of documents according to a specified pattern, reconstruct the extracted blocks into a single document, and display the result.

In the technique disclosed in Japanese Patent Laid-Open No. 11-272666, a set of generally applicable patterns including a start pattern and an end pattern and document structure information are used, and blocks between start and end patterns are extracted from a plurality of documents. The extracted blocks are put together according to the document structure information and layout information thereby obtaining a reconstructed result.

In the conventional technique described above, when a document having a fixed structure is given, a user inputs definition information indicating the document structure into the system. According to the input definition information, blocks (elements or parts) of the document are extracted and reconstructed. However, when a given document does not have a fixed structure and there is no fixed correspondence between the structure and the content of document, it is difficult to apply the above-described technique. Thus, it is desirable to further improve the technique to achieve the functionality of reconstructing various kinds of documents into a form easily understandable by a user.

### SUMMARY OF THE INVENTION

In view of the above, the present invention provides a technique to retrieve information correlated to information selected by a user from a document and present a result in a summarized manner to the user.

The present invention provides a document management apparatus including an extraction unit configured to extract one or more parts as objects from document information, a calculation unit configured to calculate a degree of association between objects for a plurality of objects extracted by the extraction unit, a storage unit configured to store the plurality of objects extracted by the extraction unit and the degree of association between objects calculated by the calculation unit, and a generation unit configured to generate presentation information in response to an operation performed by a user to specify an object included in the document information, the presentation information being for presenting objects including the user-specified object included in the document information and one or more objects that are stored in the storage unit and that have a greater or equal degree of association with the user-selected object included in the document information than or to a threshold value, wherein the generation unit generates the presentation information so that objects that are stored in the storage unit and that have a smaller degree of association with the user-specified object included in the document information than a threshold value are not presented.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a diagram illustrating a document management system according to an embodiment of the present invention.

FIG. 2 is a block diagram illustrating a hardware configuration of a personal computer included in a document management system according to an embodiment of the present invention.

FIG. 3 is a block diagram illustrating module configuration of a document management system.

FIG. 4 is a flow chart illustrating an example of a data processing procedure performed by a document management apparatus according to an embodiment of the present invention.

FIG. 5 is a diagram illustrating a document dividing process performed by a document analyzer.

FIG. 6 is a flow chart illustrating an example of a data processing procedure performed by a document management apparatus according to an embodiment of the present invention.

FIG. 7 is a diagram illustrating degrees of association between objects in documents stored in a document information storage unit.

FIG. 8 is diagram conceptually illustrating degrees of association of objects.

FIG. 9 is a diagram illustrating an example of a degree-of-association table in which degrees of association are described in numerical form.

FIG. 10 is a diagram illustrating an outline of a document reconstruction process performed in a document management system according to an embodiment of the present invention.

FIG. 11 is a flow chart illustrating an example of a data processing procedure performed in a document management system according to an embodiment of the present invention.

FIG. 12 is a diagram illustrating an example of a degree-of-association table in which degrees of association are described in numerical form.

FIG. 13 is a diagram illustrating a manner in which a document is processed by a document management apparatus according to an embodiment of the present invention.

FIG. 14 is a flow chart illustrating an example of a data processing procedure performed by a document management apparatus according to an embodiment of the present invention.

FIG. 15 is a diagram illustrating an example of a degree-of-association table stored in a degree-of-association information storage unit.

FIG. 16 is a diagram illustrating an example of document reconstruction performed in a document management system according to an embodiment of the present invention.

FIG. 17 is diagram illustrating an example of code transmitted from a document management apparatus according to an embodiment of the present invention.

FIG. 18 is diagram illustrating an example of a degree-of-association table stored in a degree-of-association information storage unit.

FIG. 19 is a diagram illustrating an example of document reconstruction performed in a document management system according to an embodiment of the present invention.

FIG. 20 is a diagram illustrating a memory map of a storage medium that stores various data processing programs readable by a document management apparatus according to an embodiment of the present invention.

### DESCRIPTION OF THE EMBODIMENTS

Embodiments of the present invention are described below with reference to accompanying drawings.

### First Embodiment

### System Configuration

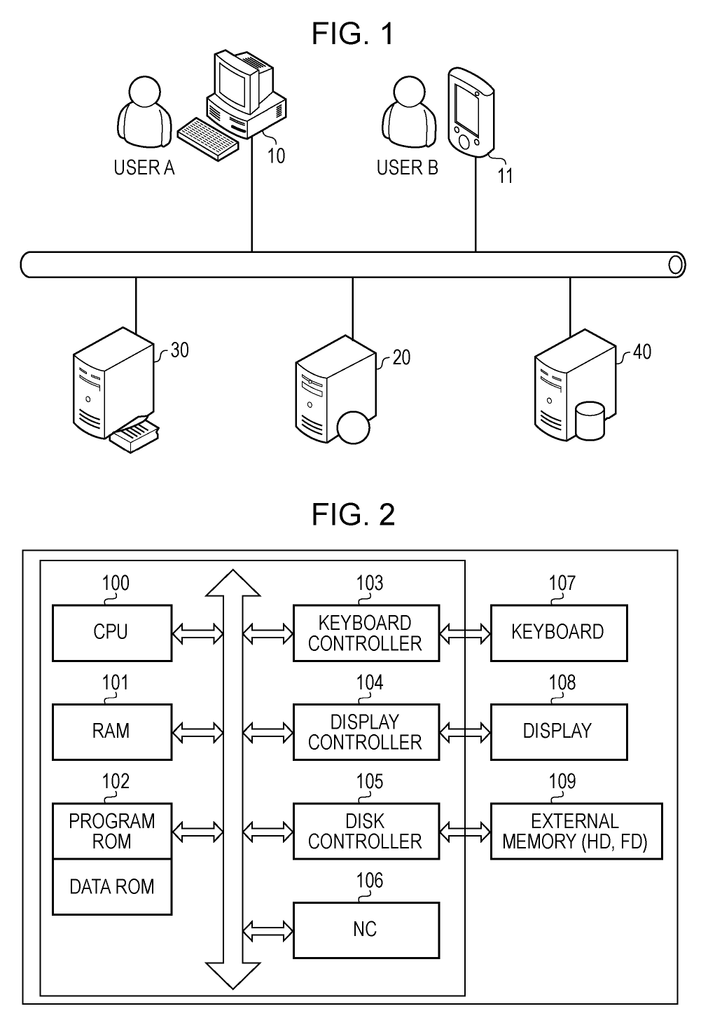

FIG. 1 is a diagram illustrating a document management system according to an embodiment of the present invention. This document management system includes a client PC 10 serving as an information processing apparatus, a mobile terminal 11, a Web application server PC 20, a user management server PC 30, and a document management server PC 40 having a capability of storing/managing documents. These units in the document management system are connected to each other via a network such that mutual communication is allowed.

In FIG. 1, the client PC 10 and the mobile terminal 11 are configured to be used by users A and B to access the document management system via a browser. The client PC 10 has a hardware resource such as that shown in FIG. 2 and also has a software resource as will be described later. The mobile terminal 11 is configured to be connectable to the network via a wireless/wired interface.

The Web application server PC 20 is configured to provide a Web application whereby the client PC 10 or the mobile terminal 11 has an operation screen necessary in document processing.

The user management server 30 is configured to manage information associated with users who access the document management system. The document management server 40 is configured to store and manage documents.

Although it is assumed in the present embodiment that the Web application server PC 20, the user management server PC 30, and the document management server PC 40 are disposed separately, they may be implemented integrally in a single PC. Furthermore, although in the present embodiment it is assumed that the user A operates the client PC 10 while the user B operates the mobile terminal 11, the terminals operated by the users A and B may be of the same type, i.e., it is not necessary that the terminals in the system should be different in type.

In the document management system according to the present embodiment it is assumed that accessing by the users A and B is performed via a browser. Alternatively, a client application may be installed on the client PC 10 or the mobile terminal 11, and accessing may be performed using the client application.

In this case, instead of accessing the Web application server PC 20, the client application may communicate with the document management server PC 40.

### Hardware Configuration

FIG. 2 is a block diagram illustrating a hardware configuration of a PC included in the document management system according to the present embodiment of the invention. Note that the hardware configuration shown in FIG. 2 is similar to a hardware configuration generally used for information processing apparatuses. That is, each PC used in the present embodiment may be configured in a similar manner in terms of hardware to a common information processing apparatus.

In FIG. 2, a CPU 100 executes programs such as an OS, an application program, or the like which may be stored in a ROM 102 serving as a program ROM or which may be loaded in a RAM 101 from an external memory 109 such as a hard disk.

Note that OS is an abbreviation for “operating system” which runs on a computer. Hereinafter, the abbreviated-expression “OS” is used to describe “operating system”. Processes described below with reference to flow charts are performed by executing corresponding programs on the OS.

The RAM 101 functions as a main memory or a work area used by the CPU 100. A keyboard controller 103 controls key-inputting via a keyboard 107 or a pointing device (not shown). A display controller 104 controls a displaying operation of a display 108. A disk controller 105 controls accessing of data to an external memory 109 such as a hard disk (HD) or a floppy disk (FD) for storing various kinds of data.

A network controller (NC) 106 connected to a network controls communication with other devices connected to the network. Note that the units 101 to 109 described above are connected to a system bus, and accessing operations thereof are controlled by the CPU 100.

### Software Configuration

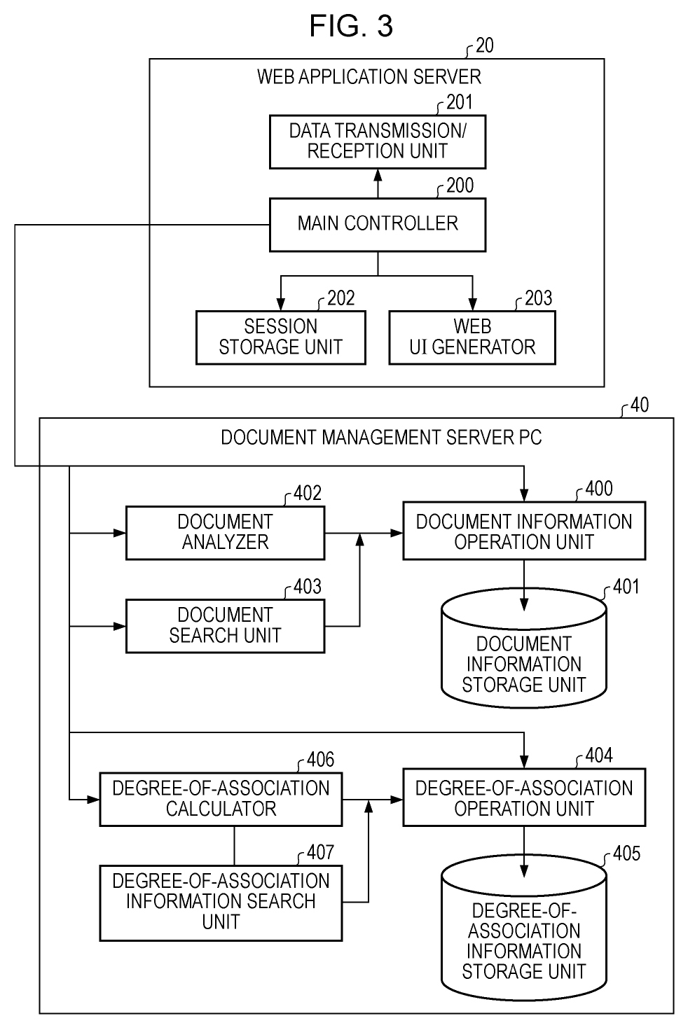

FIG. 3 is a block diagram illustrating a module configuration of the document management system shown in FIG. 1. In this figure, software configurations of the Web application server PC 20 and the document management server PC 40 in the document management system are illustrated. A main controller 200 is responsible for control over the entire document management system according to the present embodiment of the invention. For this purpose, the main controller 200 issues instructions to various parts to control them as described later.

In the Web application server 20 shown in FIG. 3, a data transmission/reception unit 201 is configured to receive a command issued by a user via the client PC 10 or the like and return a result of an instruction issued by the main controller 200 to the client PC 10.

If the user accesses the document management system via a browser on the client PC 10, a session storage unit 202 produces session information including information indicating that the access is from this user. The session storage unit 202 stores various kinds of information used repeatedly in association with the session information until the user logs off the document management system or the session is terminated due to automatic timeout or the like.

A Web UI generator 203 is configured to operate under the control of the main controller 200 to generate a Web UI (HTML) depending on a situation.

Note that Web UIs generated by the Web UI generator 203 is not limited to those in the HTML format, but other formats may be used. For example, Web UIs may be described in a form in which a script language such as a Java (registered trademark) script is embedded.

In the document management server 40 shown in FIG. 3, a document information operation unit 400 is configured to operate under the control of the main controller 200 to register a document entity, objects obtained as a result of dividing of a page of a document, and metadata of the objects in a document information storage unit 401. The document information operation unit 400 also performs other operations such as extracting, editing, etc., on the data stored in the document information storage unit 401 such as the document entity, the objects obtained as the result of the dividing of the page of the document, and the metadata of the objects.

A document analyzer 402 is configured to operate under the control of the main controller 200 to analyze pages of documents, divide the pages into blocks, add metadata to respective objects obtained as the result of the dividing of the pages into blocks, and registers them in the document information storage unit 401 via the document information operation unit 400.

The document search unit 403 is configured to operate under the control of the main controller 200 to search for document entities and objects from the document information storage unit 401 via the document information operation unit 400 and acquire document entities and objects found in the search operation.

A degree-of-association calculator 406 is configured to operate under the control of the main controller 200 to calculate the degrees of association between objects for the objects stored in the document information storage unit 401 and register the calculated degrees of association in a degree-of-association information storage unit 405 via a degree-of-association information operation unit 404.

A degree-of-association information search unit 407 is configured to operate under the control of the main controller 200 to search for degree-of-association information between objects from the degree-of-association information storage unit 405 via the degree-of-association information operation unit 404 and acquire the degree-of-association information found in the search operation.

The process of dividing into objects and the process of identifying the objects performed in the document management system according to the present embodiment of the invention are described in further detail below.

In the document management server 40, documents are divided into blocks and stored as objects.

### Process of Dividing Into Objects and Identifying Objects

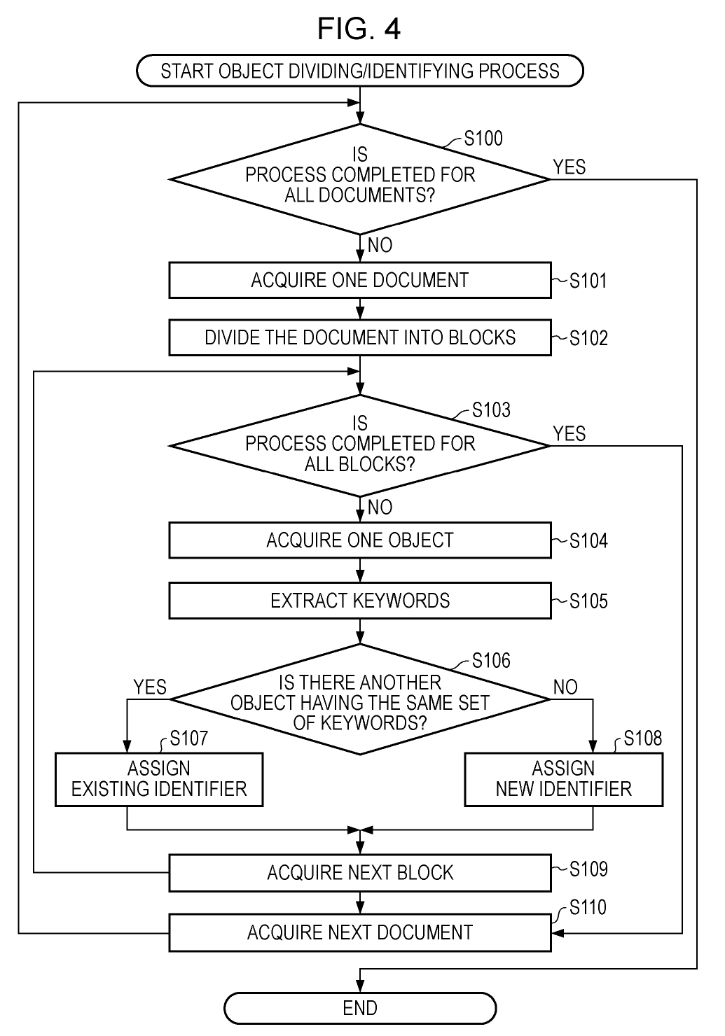

FIG. 4 is a flow chart illustrating an example of a data processing procedure performed by the document management apparatus according to the present embodiment of the invention. In FIG. 4, S100 to S110 denote step numbers. These steps are performed by the CPU of the document management server 40 by executing the modules shown in FIG. 3.

In step S100, the document information operation unit 400 determines whether the documents stored in the document information storage unit 401 includes any document that has not been yet subjected to the process of dividing into objects. If it is determined by the document information operation unit 400 in step S100 that there is one or more documents that have not yet been subjected to the process of dividing into objects, then the process proceeds to step S101. In step S101, the document information operation unit 400 acquires one document. In step S102, the document analyzer 402 divides the acquired document into blocks (elements or parts) thereby extracting objects. In this process, the document information operation unit 400 also extracts location information of each object and registers the location information in the document information storage unit 401 in such a manner that the location information is correlated to the corresponding objects.

Note that the object extraction may be performed by executing an application program to analyze a document and divide it into blocks according to a known technique.

For example, a chunk of text may be divided by paragraph, and images, graphs, and tables may be extracted from the document.

The granularity of the division into blocks may be determined automatically or may be specified by a user. A result of the automatic dividing into blocks may be presented to a user, and the user may modify the result.

Next, in step S103, the document information operation unit 400 determines whether the process is completed for all blocks, i.e., objects, in the document. If the determination made in step S103 by the document information operation unit 400 is that there is one or more objects that have not yet been processed, then the process proceeds to step S104. In step S104, the document information operation unit 400 acquires one object.

Next, in step S105, the document analyzer 402 extracts keywords in the object and registers the extracted keywords as metadata of the object in the document information storage unit 401 via the document information operation unit 400 in such a manner that the keywords are correlated to the object.

Next, in step S105, the document search unit 403 performs searching via the document information operation unit 400 to check whether there is one or more other objects having the same set of keywords. In the searching, it may be required as a search condition that all keywords should be equally included, or the search condition may be that the number of occurrences is counted for each of a plurality of keywords and a predetermined number of keywords that are in highest positions in the number of occurrences are extracted. In the latter case, a threshold value may be preset in the system or may be specified by a user.

In a case where an object is text, the keyword extraction may be performed using a common morphological analysis technique or the like.

Next, in step S106, the document information operation unit 400 determines whether there is an existing object having the same set of keywords as that of the object being currently processed. If the determination made by the document information operation unit 400 is that there is such an existing object, then in step S107, the document information operation unit 400 assigns the same identifier to the object being currently processed as that of the existing object.

On the other hand, in a case where the determination made in step S106 by the document information operation unit 400 is that there is no existing object having the same set of keywords as that of the object being currently processed, the process proceeds to step S108. In step S108, the document information operation unit 400 assigns a new identifier to the object being currently processed.

Next, in step S109, the document information operation unit 400 acquires a next block. The process then returns to step S103.

In a case where it is determined in step S103 by the document information operation unit 400 that all blocks, i.e., all objects in the document have been processed, the process proceeds to step S110. In step S110, the document information operation unit 400 acquires a next document. The process then returns to step S100.

If it is determined in step S100 by the document information operation unit 400 that all documents in the document information storage unit 401 have been processed, the present process is ended.

In the present embodiment described above, by way of example, it is assumed that the documents stored in the document information storage unit 401 include one or more documents that have not yet been processed. Alternatively, the document processing may be performed each time a document is registered by a user in the document management server 40.

In a case where objects are images or the like, object identification may be performed by extracting a feature value of an object and comparing it with feature values of other objects.

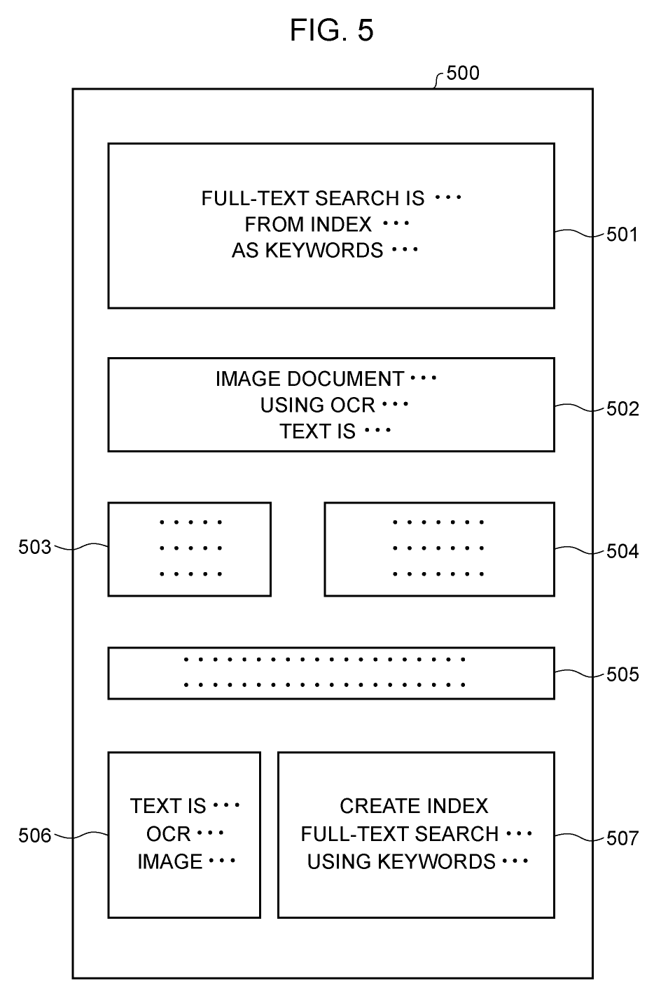

FIG. 5 illustrates a document dividing process performed by the document analyzer 402 shown in FIG. 3.

In FIG. 5, reference numeral 500 denotes a document stored in the document information storage unit 401. Reference numerals 501 to 507 denote objects obtained as a result of the division into blocks performed by the document analyzer 402. If sets of keywords extracted by the document analyzer 402 are the same for the object 501 and the object 507, then it is determined that these objects are identical. In this case, in step S107 shown in FIG. 4, the same identifier is assigned to these objects. Objects 502 and 506 are treated in a similar manner. That is, objects that are similar in content are assigned the same identifier so that these objects are identified by the assigned identifier. Calculation of degree of association between objects

In the present embodiment, after the objects are extracted and identified in the above-described manner, the degree of association between objects is calculated and stored in the degree-of-association information storage unit 405 of the document management server 40.

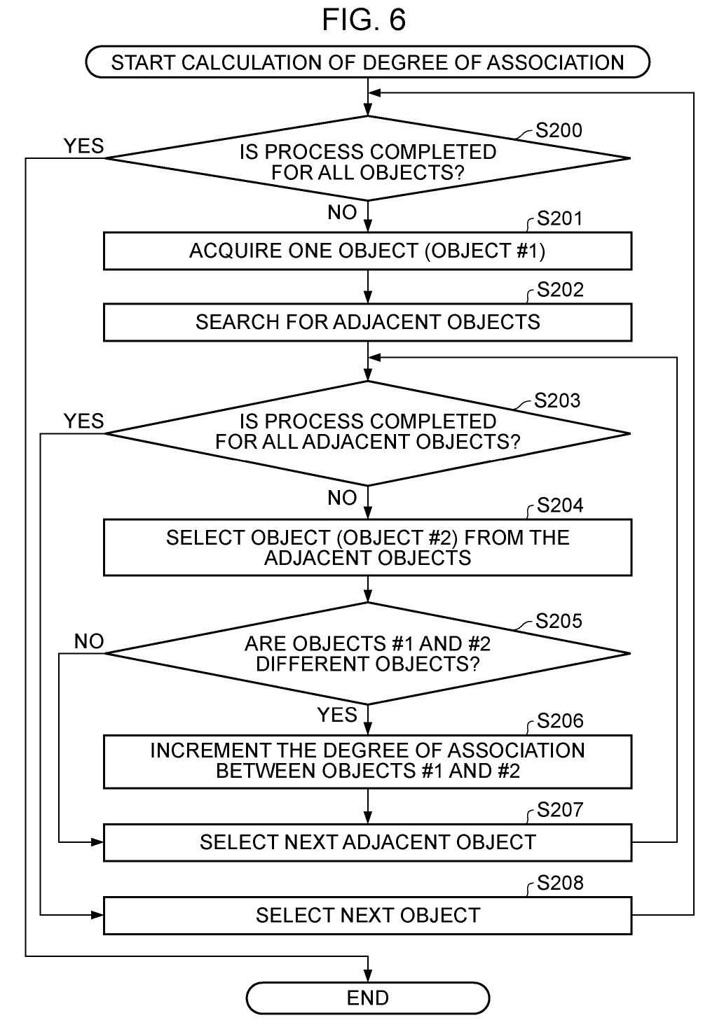

FIG. 6 is a flow chart illustrating an example of a data processing procedure performed by the document management apparatus according to the present embodiment of the invention. In this example, data processing performed by the degree-of-association calculator 406 of the document management server 40 shown in FIG. 1 is illustrated. More specifically, degrees of association between data objects are calculated and the calculated degrees of association are described in the form of a table. In FIG. 6, S200 to S208 denote step numbers. These steps are performed by the CPU of the document management server 40 by executing the degree-of-association calculator 406.

First, in step S200, the degree-of-association calculator 406 makes a determination via the document information operation unit 400 as to whether the objects stored in the document information storage unit 401 includes any object that has not yet been subjected to the calculation of the degree of association. If the determination made in step S200 by the degree-of-association calculator 406 is that there is one or more objects that have not yet been processed, then in step S201 the document information operation unit 400 acquires one object. Let this object be denoted, for example, as an object #1.

Next, in step S202, the degree-of-association calculator 406 searches, via the document search unit 403 and the document information operation unit 400, for objects adjacent in the document to the object #1.

Next, in step S203, the degree-of-association calculator 406 determines whether the adjacent objects found in the search process include an object that has not yet been subjected to the calculation of the degree of association. If the determination made in step S203 by the degree-of-association calculator 406 is that there is one or more objects that have not yet been subjected to the calculation of the degree of association, then in step S204 the document information operation unit 400 acquires one such adjacent object. Let this object be denoted, for example, as an object #2.

Next, in step S205, the degree-of-association calculator 406 checks whether the object #1 and the object #2 have the same identifier. If the determination made in step S205 by the degree-of-association calculator 406 is that these two objects do not have the same identifier, then in step S206 the degree-of-association calculator 406 increments the degree of association between the objects #1 and the object #2, and registers the result in the degree-of-association information storage unit 405 via the degree-of-association information operation unit 404. This makes it possible to manage the correlation between objects identified by different identifiers. Next, in step S207, the degree-of-association calculator 406 acquires a next adjacent object. The process then returns to step S203.

On the other hand, in a case where it is determined in step S203 by the degree-of-association calculator 406 that all adjacent objects have been processed, then in step S208 the degree-of-association calculator 406 acquires a next object via the document information operation unit 400. The process then returns to step S200.

If it is determined in step S200 by the degree-of-association calculator 406 that all objects in the document information storage unit 401 have been processed, the present process is ended.

In the example described above, for convenience of illustration, the object extraction process, the identification process, and the degree-of-association calculation process are described separately. However, these processes may be performed simultaneously.

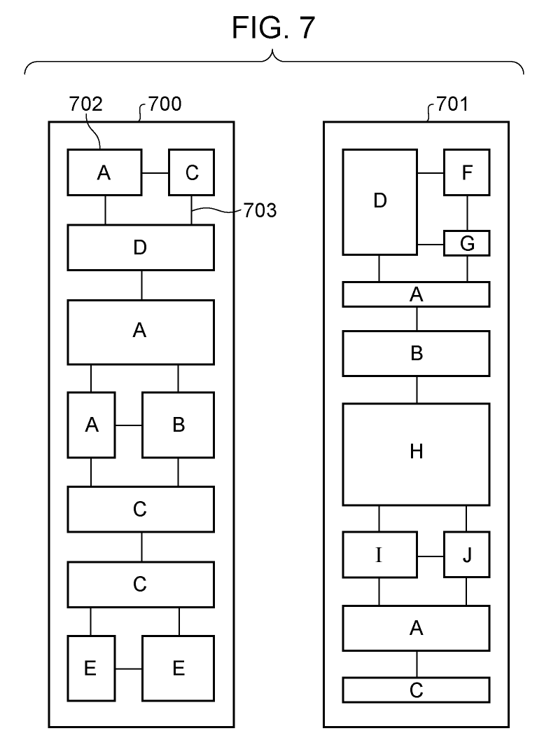

FIG. 7 illustrates degrees of association between objects in documents stored in the document information storage unit 401 shown in FIG. 3.

In FIG. 7, reference numerals 700 and 701 denote documents stored in the document information storage unit 401. For simplicity, it is assumed that there are only two documents in the document information storage unit 401. Reference numeral 702 denotes an object detected in the document 700. This object 702 is assigned an identifier, for example, “A”. Reference numeral 703 denotes a line indicating that two objects connected by this line are adjacent to each other in the document.

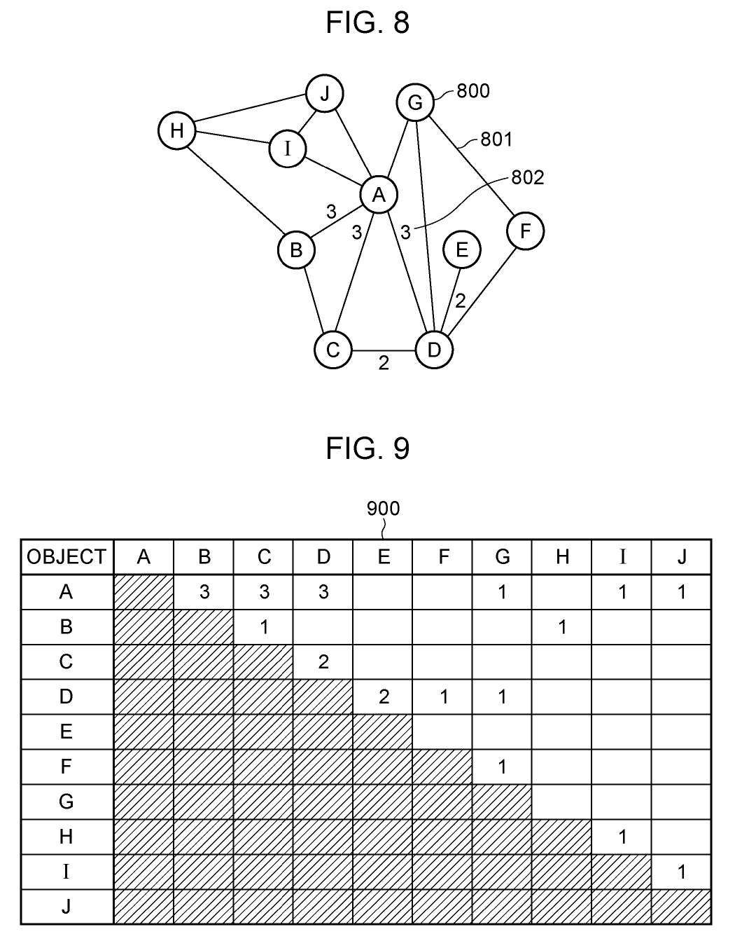

FIG. 8 conceptually illustrates degrees of association of objects shown in FIG. 7. In this example, the figure shows objects in the two documents 700 and 701 and degrees of association thereof.

In FIG. 8, reference numeral 800 denotes an object having an identifier “A”. Reference numeral 801 denotes a line indicating association between two objects. Reference numeral 802 denotes a value indicating a degree of association. In this example, the degree of association is increased by +1 each time a line 703 is drawn. In the following description, an object assigned an identifier “X” is denoted simply as an object X.

In FIG. 8, objects that frequently appear at adjacent locations are conceptually shown. That is, in this example, the object A has a high degree of association with objects B, C, and D.

In the present example, the degree of association is simply incremented by +1. However, the degree of association may be increased in different manners, as described later.

FIG. 9 illustrates an example of a degree-of-association table in which the degrees of association shown in FIG. 8 are described in numerical form. Note that this table is stored in the degree-of-association information storage unit 405 and managed thereby.

In FIG. 9, reference numeral 900 denotes a table indicating degrees of association between objects. More specifically, the degrees of association shown in FIG. 8 are represented by values and described in the table.

### Document Reconstruction Process

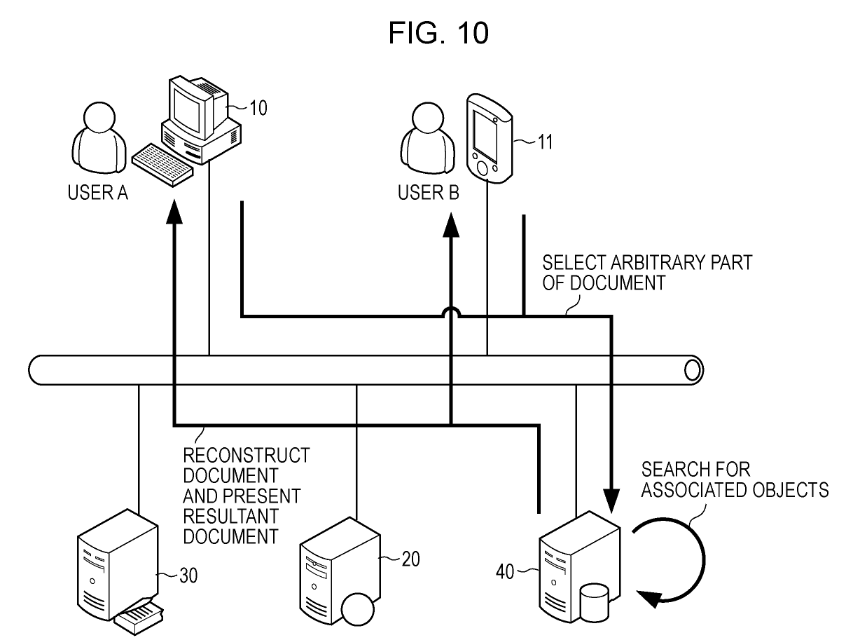

Let us assume that a user has selected an arbitrary point in a document on the client PC 10 or the mobile terminal 11 with a mouse or the like. In response, the document management server 40 reconstructs a set of objects having related to an object corresponding to the selected block, and the document management server 40 presents the result to the user. The document reconstruction process is described in further detail below with reference to FIG. 10 and other figures.

FIG. 10 illustrates an outline of the document reconstruction process performed in the document management system according to the present embodiment of the invention.

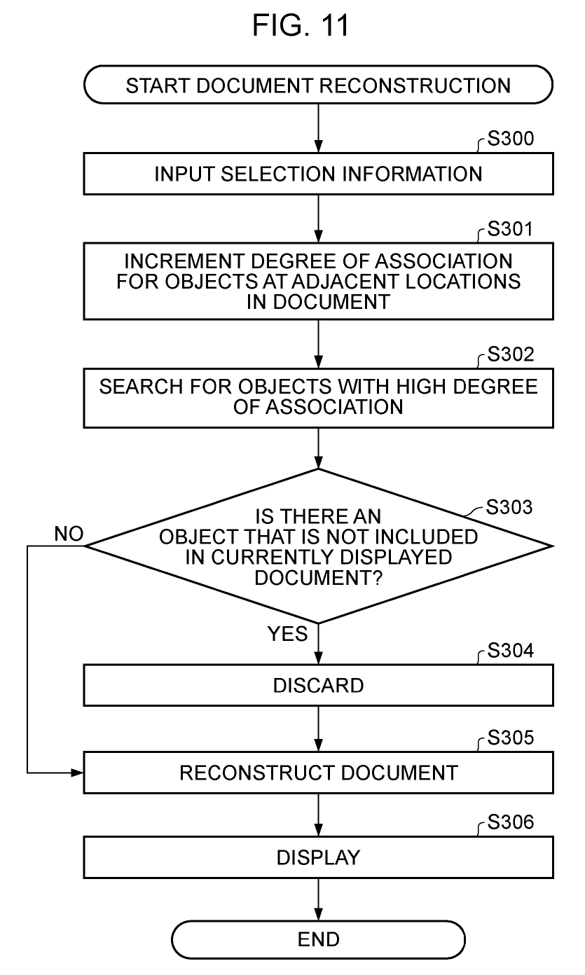

FIG. 11 is a flow chart illustrating an example of a data processing procedure performed in the document management system according to the present embodiment of the invention. In this example shown in FIG. 11, a document reconstruction process is performed in the document management system. In FIG. 11, S300 to S306 denote step numbers. Steps S300 and S306 are executed by the main controller 200 in the Web application server 20, while steps S301 to S305 are executed by the CPU in the document management server PC 40.

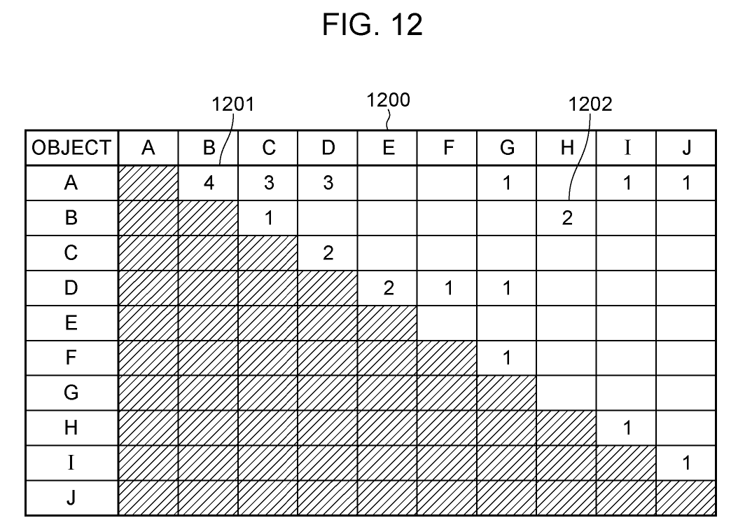

FIG. 12 illustrates an example of a degree-of-association table in which the degrees of association shown in FIG. 8 are described in numerical form. This table is obtained as a result of the recalculation performed in step S301. The table is stored in the degree-of-association information storage unit 405 and is managed thereby.

In FIG. 12, it is assumed by way of example that an object B in the document 700 shown in FIG. 7 is selected by a user. In this case, objects that are located in the document 701 and that are adjacent to the selected object B are an object A and an object H. Therefore, in the table shown in FIG. 12, values in fields 1201 and 1202 are greater than those in the table shown in FIG. 9. Although in this example the increasing amount is set to +1, the value may be increased in different manners. For example, the value may be multiplied by an integer. Thus, in this case, the objects A, H, and C are detected as objected related to the object B.

Now, the document reconstruction process is described below with reference to the flow chart shown in FIG. 11.

In step S300, the main controller 200 receives, via the data transmission/reception unit 201, object information indicating an object selected by a user from a document being currently displayed. In step S301, the degree-of-association calculator 406 increases the degree of association between the object selected by the user and objects adjacent to the object selected by the user, and the degree-of-association calculator 406 tentatively updates the degree-of-association table. The details of the updated table will be described later.

Next, in step S302, the degree-of-association information search unit 407 searches the document information storage unit 401 to find objects having high degrees of association with the object selected by the user, and the degree-of-association information search unit 407 sends information associated with the detected objects to the document search unit 403.

Next, in step S303, the document search unit 403 searches for the objects based on the information received in step S302 from the degree-of-association information search unit 407. The document search unit 403 determines whether the objects detected in the search include any object that is not included in the document being currently displayed. If the determination by the document search unit 403 is that there is one or more objects that are not included in the document being currently displayed, then in step S304 the document information operation unit 400 discards such objects from candidates for objects to be reconstructed. Next, in step S305, the document information operation unit 400 produces a document reconstructed from the detected objects. In the document reconstruction, objects having degrees of association greater than a predetermined threshold value may be selected from the objects detected in the search, and the selected objects may be displayed. Objects having degrees of association smaller than a predetermined threshold value may be discarded so as not to be included in the reconstruction. The threshold values may be specified by a user.

The objects may be put in the reconstructed document in the same order as the order in which the objects are located in the original document being currently displayed, or may be arranged in the order of degree of association from highest to lowest. The location order of objects may be switched by a user.

Next, in step S306, the document information operation unit 400 transfers information associated with the reconstruction to the Web UI generator 203. The Web UI generator 203 generates information for displaying reconstructed pages and transmits the generated information to the client PC 10 or the mobile terminal 11 operated by the user. After that, the present process is ended. Thus, it becomes possible for the user to view the document reconstructed based on the correlation among objects included in the document so as to represent the content of the original document in a summarized manner on the client PC 10 or the mobile terminal 11 via the browser.

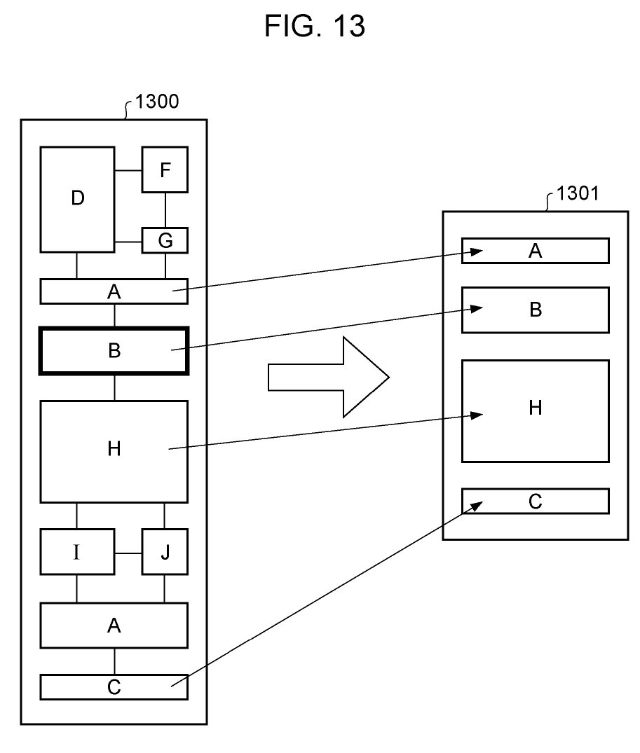

FIG. 13 illustrates a manner in which a document is processed by the document management apparatus according to the present embodiment of the invention.

In FIG. 13, reference numeral 1300 denotes a document in a state in which the document has not yet been subjected to reconstruction. Reference numeral 1301 denotes a reconstructed document to be presented to a user. In this example, as in the example shown in FIG. 12, it is assumed that an object B in the document 1300 is selected by a user.

In FIG. 12, objects related to the objects B are an object A, an object H, and an object C. Thus, in the document 1301, a page is produced so as to include the object A, the object B, the object H, and the object C.

The objects may be put at locations in accordance with the order in the original document or may be put at locations in order of the degree of association from highest to lowest. The object C has a low degree of association, and thus it may not be displayed.

In the first embodiment described above, the calculation of the degree of association is performed for all documents in the document management server 40. Depending on the operational situation, a selection may be made as to which range of documents should be subjected to the calculation of the degree of association.

In the selection of the range, the minimum unit is one page of a document. The range may be specified in various units such as pages, documents, cabinets (units of a database), etc. The maximum unit is a database.

In general, the greater the range, the more collective intelligence is achieved. However, in a case where a document is in a particular genre, if the degree of association is calculated for a wide range beyond the genre, the result can include noise. The document search range may be increased to a proper extent as required. The proper range may be specified by a user.

In the present embodiment, it is assumed that objects used in the reconstruction are within a document being currently displayed. However, objects included in other documents may also be added. In this case, information may be displayed to clearly inform that objects belong to other documents.

### Second Embodiment

A document management system according to a second embodiment is described below. The document management system according to the second embodiment is similar to that according to the first embodiment except that the degree of association calculated by the degree-of-association calculator 406 is weighted differently depending on the relative locations of objects or other factors.

### Calculation of Degree of Association

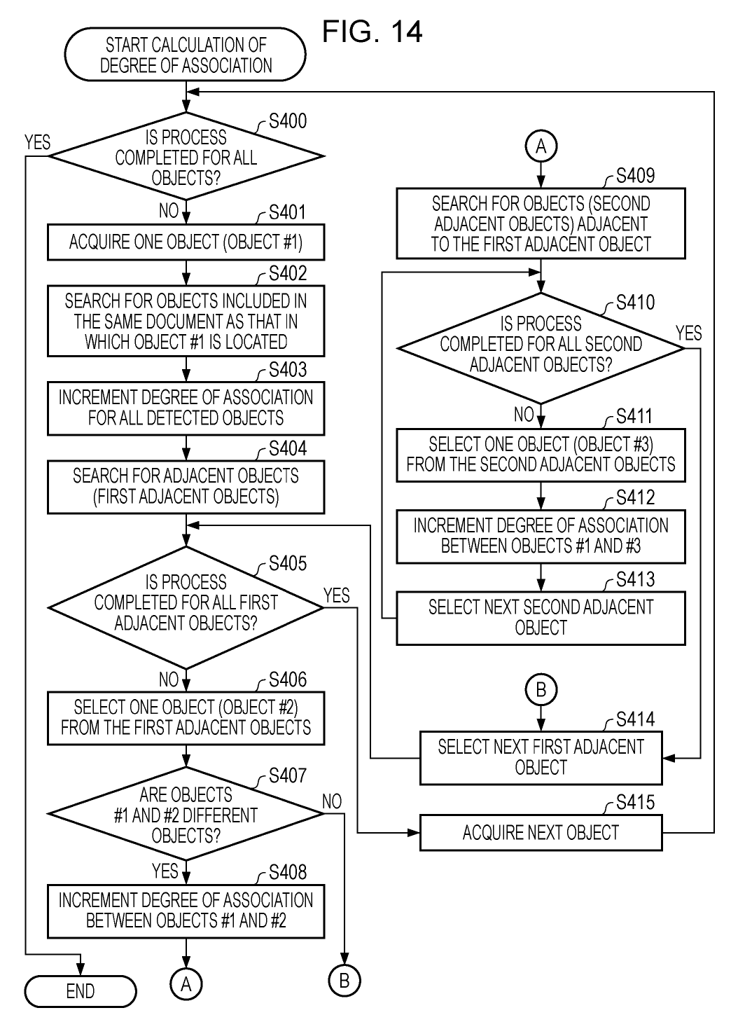

In the first embodiment described above, the determination of the degree of association in step S206 shown in FIG. 6 is performed simply by incrementing the degree of association by +1 for adjacent objects. In contrast, in the second embodiment, the degree of association between objects is calculated in a manner extended from the manner employed in the first embodiment, as described below with reference to FIG. 14.

FIG. 14 is a flow chart illustrating an example of a data processing procedure performed by the document management apparatus according to the present embodiment of the invention. In this example, the degree of association is calculated by the degree-of-association calculator 406. In FIG. 14, S400 to S415 denote step numbers. These steps are performed by the CPU of the document management server 40 by executing the degree-of-association calculator 406. In the following description, a duplicated explanation is omitted for processes similar to those in the first embodiment described above with reference to FIG. 6.

Steps S400 and S401 are similar to step S200 and S201 shown in FIG. 6.

In step S402, the degree-of-association calculator 406 performs searching, via the document search unit 403, to detect all objects existing in the same document as that in which the object #1 is located. Next, in step S403, the degree-of-association calculator 406 increases the degree of association for all objects detected in step S402. The ratio/amount of the increase in the degree of association may be set to be smaller than that used in step S206. For example, when the degree of association is increased by +1 in step S206, the degree of association may be increased by +0.1 in step S403.

The following steps S404 to S408 are similar to step S202 to S206. If the determination in step S407 is negative, the process jumps to step S414.

Next, in step S409, the document search unit 403 searches for objects adjacent to the respective objects detected in step S404. Steps S410, S411, and S413 in the following process are different from steps S203, S204, and S207 shown in FIG. 6 in terms of the degree of adjacency, i.e., in terms of whether objects are adjacent to each other via one intervening object or via two intervening objects.

Next, in step S412, the degree-of-association calculator 406 increases the degree of association for the object #1 and objects indirectly adjacent to the object #1 via one intervening object. The ratio/amount of the increase in the degree of association may be set to be smaller than that used in step S206. For example, when the degree of association is increased by +1 in step S206, the amount of increase in the degree of association in step S412 may be +0.5.

Steps S414 and S415 are similar to steps S207 and S208 in FIG. 6.

In the present example, the number of intervening objects is up to two. However, there is no particular restriction on the number of intervening objects, and the degree of association may be calculated also for objects adjacent via three or more intervening objects. The amount of increasing the degree of association may be reduced with distance between objects of interest.

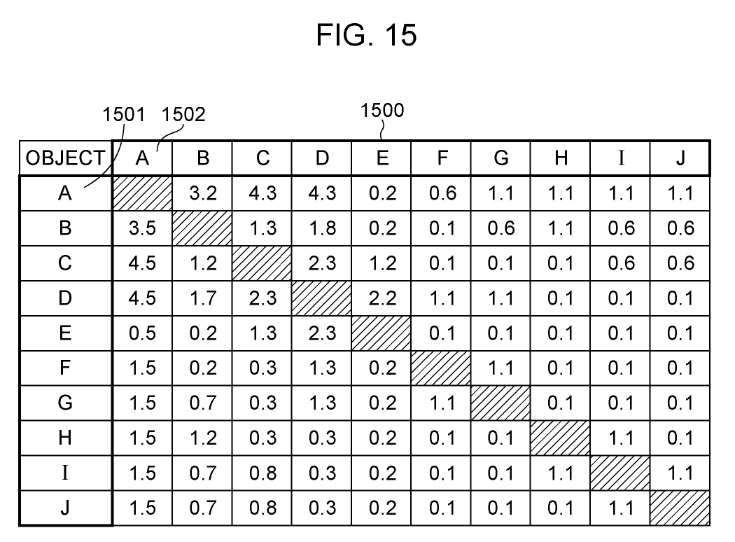

FIG. 15 illustrates an example of a degree-of-association table stored in the degree-of-association information storage unit 405 shown in FIG. 3. Note that this table is in a state in which the process shown in FIG. 14 is completed.

In the example shown in FIG. 15, the increasing amount in step S403 in FIG. 14 is set to +0.1, and that in step S412 is set to +0.5.

In FIG. 15, the degree of association of an object in each column 1502 with respect to an object in each row 1502 is described in a corresponding field. In this example, the process in step S403 in FIG. 14 can cause the degree of association between two objects to have different values depending on which one of the two objects is employed as a reference.

For example, the degree of association of the object C with respect to the object A is 4.3. However, the degree of association of the object A with respect to the object C is 4.5.

In step S408 in FIG. 14, the increasing amount of the degree of association may be modified depending on a connecting area between objects.

For example, in a case of an object H shown in FIG. 7, the object B is adjacent to the object H across a greater connecting area than a connecting area across which the object I or the object J is adjacent to the object H. Thus, it can be concluded that the object B has a greater degree of association with the object H than the object I or the object J has. The specific value of the degree of association may be calculated, for example, according to the following formula.

Degree of association=Original degree of association×((length of shorter side of connecting area)/(length of longer side of connecting area))

### Third Embodiment

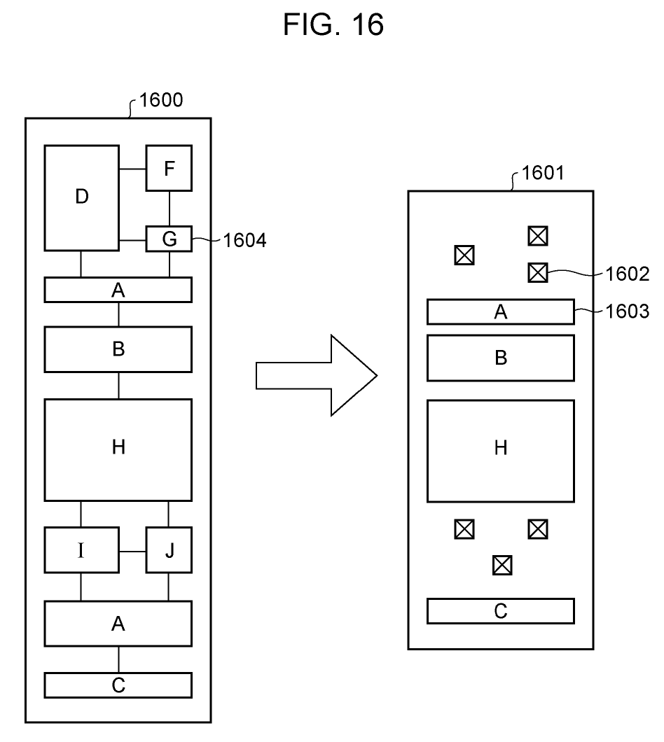

A third embodiment of the present invention is described below with reference to FIG. 16. A document management system according to the third embodiment is different from that according to the first embodiment in the manner in which the document is presented by the Web UI generator 203 and is also different in that the document is reconstructed in accordance with a selection made by a user.

In the document management system according to the third embodiment of the present invention, not only reconstructed objects are displayed but other original objects are also displayed in the form of symbols or the like so that when a symbol is selected by a user, the content of the corresponding object is displayed. Furthermore, the document may be reconstructed using previously selected objects and currently selected objects.

### Document Reconstruction Process

FIG. 16 illustrates an example of document reconstruction performed in the document management system according to the present embodiment of the invention.

In FIG. 16, reference numeral 1600 denotes a document in a state in which the document has not yet been subjected to reconstruction. Reference numeral 1601 denotes an example of a reconstructed document. In the first embodiment shown in FIG. 13, only objects related to an object selected by a user are displayed.

In contrast, in the example shown in FIG. 16, even objects determined to have no correlation are displayed in the form of symbols such as a mark x denoted by reference numeral 1602 in FIG. 16, although contents thereof are not directly displayed. Note that the symbol is not limited to x, but other symbols may be used. Instead of displaying symbols, keywords or abstracts of objects may be displayed. Alternatively, types of objects such as “text”, “graph”, “image”, etc., may be displayed.

The mark x is an object indicating not the content itself of an original object but indicating that there is the original object at the location where the mark x is displayed. The mark is not limited to x as long as the mark has a size smaller than the size of the original object. When an object including a mark x is displayed on the client PC 10, if this object is selected via an operation performed by a user, a program is executed by the document management server 40.

Although in the example shown in FIG. 16, marks x are displayed in areas with the same sizes as those of the original objects, marks x may be displayed in reduced areas. In the example shown in FIG. 16, there are two objects A. In such a case, the content of the second object A may be displayed or a mark or a message may be displayed to inform that the second object is the same or similar as/to the first object A.

In the case where objects are displayed in the form of marks x as shown in FIG. 16,, if one of the marks x is selected by a user, then the main controller 200 searches via the document search unit 403 for a corresponding object and acquires the object via the document information operation unit 400. The Web UI generator 203 generates information for displaying the further reconstructed document including the acquired original object. In general, the selection command may be issued by a user by clicking a pointing device, although other devices or other methods may be used.

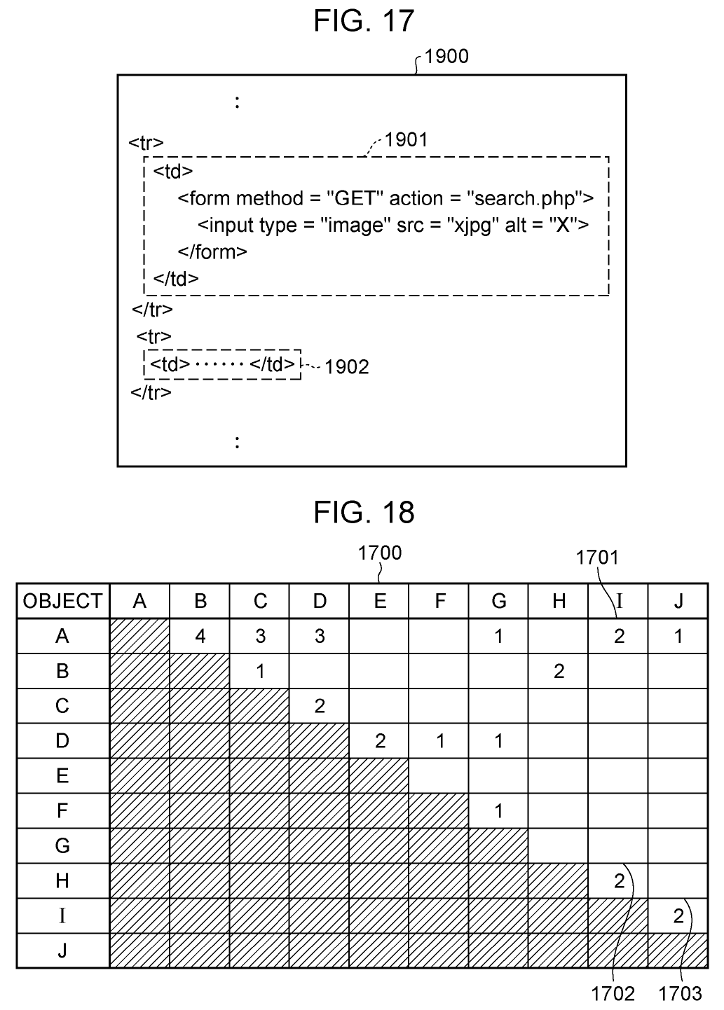

FIG. 17 illustrates an example of code transmitted from the document management apparatus according to the present embodiment of the invention. This example shown in FIG. 17 is a part of a total code set 1900 transmitted from the document management server 40 to the client PC 10 or the mobile terminal 11 shown in FIG. 1.

In FIG. 17, reference numeral 1901 denotes a code part for displaying a mark 1602 shown in FIG. 16. In this example, the code part is configured such that when an image of a mark x is clicked by a user via a pointing device or the like, a program is executed on the document management server 40.

In the document management server 40, the document search unit 403 searches for an object 1604 corresponding to an object G shown in FIG. 16 from the document information storage unit 401, and the Web UI generator 203 reconstructs the page.

A code part 1902 is configured to display an object 1603 corresponding to the object A shown in FIG. 16.

Note that the code set 1900 shown is merely an example, and parts that are not essential to the present embodiment are not shown. Furthermore, although in this example PHP (Hypertext Preprocessor) is called by HTML (Hyper Text Markup Language), other languages may be used as long as similar operations can be achieved.

As described above, in addition to providing the functionality of simply redisplaying the content of an object when a corresponding mark x is selected, a functionality may be provided to reconstruct the document according to both previous and current selections.

In this case, the process involves re-performing the flow shown in FIG. 11 for newly selected objects and recalculating the degree-of-association table. Referring to the flow chart shown in FIG. 11, the process is described in further detail below.

In step S302, searching is performed to detect the degrees of association for both previously selected objects and currently selected objects, and objects are acquired. For example in the document 1600 shown in FIG. 16, if a mark x corresponding to an object I is selected by a user, then the degree-of-association table shown in FIG. 12 is modified as shown as a table 1700 in FIG. 18. That is, in response to the selection of the object I, the degree of association is increased by +1 for 1701, 1702, and 1703.

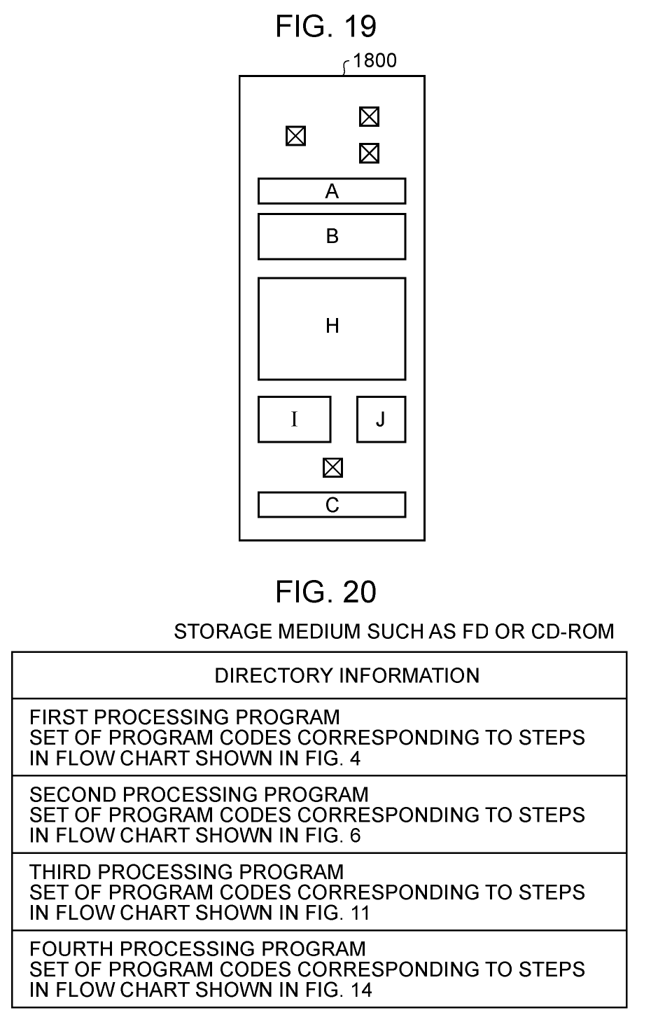

In step S302 in FIG. 11, the degree-of-association information search unit 407 searches for not only the degree of association of the previously selected objects but also the degree of association of the currently selected objects. As a result of the selection of the object I, it is determined that an object J has come to now have association, and thus a document 1800 shown in FIG. 19 is presented to a user.

Next, with reference to a memory map shown in FIG. 20, a data processing program readable by the document management apparatus is described below.

FIG. 20 a diagram illustrating a memory map of a storage medium that stores various data processing programs readable by a document management apparatus according to an embodiment of the present invention.

Information for managing the programs stored in the storage medium, such as information indicating the version, a producer, or the like, and/or other additional information, such as icons indicating respective programs, depending on an operating system (OS) that reads the programs may also be stored in the storage medium.

Data associated with respective programs are also managed by directories. A program for installing a program on a computer may also be stored on the storage medium. When a program to be installed is stored in a compressed form, a program for decompressing the program may also be stored on the storage medium.

The functions shown in FIG. 4, FIG. 6, FIG. 11, or FIG. 14 according to the present embodiment may be realized by installing a program from the outside and executing it on a host computer. In this case, information including the program according to the present invention may be supplied to the host computer from a storage medium such as a CD-ROM, a flash memory, or an FD, or from an external storage medium via a network.

The present invention may also be practiced by supplying a medium such as a storage medium having a software program code stored therein to an apparatus, loading the software program code from the medium onto a computer (or a CPU or an MPU) of a system or an apparatus, and executing the software program on the computer.

In this case, the program code read from the storage medium implements the novel functions disclosed in the embodiments described above, and the storage medium on which the program code is stored falls within the scope of the present invention.

In this case, there is no particular restriction on the form of the program as long as it functions as a program. That is, the program may be realized in various forms such as an object code, a program executed by an interpreter, script data supplied to an operating system, etc.

Storage media which can be employed in the present invention to supply the program include a floppy disk, a hard disk, a CD-ROM disk, a CD-R disk, a CD-RW disk, a non-volatile memory card, and a ROM. In this case, the program code read from the storage medium implements the functions disclosed in the embodiments described above, and the storage medium on which the program code is stored falls within the scope of the present invention.

The program may also be supplied such that a client computer is connected to an Internet Web site via a browser, and an original computer program or a file including a compressed computer program and an automatic installer may be downloaded into a storage medium such as a hard disk of the client computer thereby supplying the program. The program code of the program according to an embodiment of the present invention may be divided into a plurality of files, and respective files may be downloaded from different Web sites. Thus, a WWW server, an ftp server and similar servers that provide a program or a file that allows the functions according to an embodiment of the present invention to be implemented on a computer also fall within the scope of the present invention.

The program according to the present invention may be stored in an encrypted form on a storage medium such as a CD-ROM and may be distributed to users. Particular authorized users are allowed to download key information used to decrypt the encrypted program from a Web site via the Internet. The decrypted program may be installed on a computer using the downloaded key information thereby achieving the one or more functions according to any embodiment of the present invention.

The functions disclosed in the embodiments may be implemented not only by executing the program code on a computer, but part or all of the process may be performed by an operating system or the like running on the computer in accordance with the program code. Such implementation of the functions also falls within the scope of the present invention.

Furthermore, the scope of the present invention also includes an apparatus/system in which a program code is loaded from a storage medium into a memory provided on a function extension board inserted in a computer or provided in a function extension unit connected to the computer, and then a part of or the whole of a process is performed by a CPU or the like in the function extension board or the function extension unit in accordance with the program code thereby implementing the functions of any embodiment described above.

Note that the present invention is not limited to the details of the embodiments described above, but various modifications (including combinations of embodiments) are possible without departing from the spirit and the scope of the present invention.

While the present invention has been described with reference to exemplary embodiments, it is to be understood that the invention is not limited to the disclosed exemplary embodiments. The scope of the following claims is to be accorded the broadest interpretation so as to encompass all modifications and equivalent structures and functions.

This application claims the benefit of Japanese Patent Application No. 2008-182905 filed Jul. 14, 2008, which is hereby incorporated by reference herein in its entirety.

What is claimed is:

1. A document management apparatus comprising:
an extraction unit configured to extract one or more parts as objects from document information;
a calculation unit configured to calculate a degree of association between objects for a plurality of objects extracted by the extraction unit;
a storage unit configured to store the plurality of objects extracted by the extraction unit and the degree of association between objects calculated by the calculation unit;
a generation unit configured to generate presentation information in response to an operation performed by a user to specify an object included in the document information, the presentation information being for presenting objects including the user-specified object included in the document information and one or more objects that are stored in the storage unit and that have a greater or equal degree of association with the user-selected object included in the document information than or to a threshold value,
wherein the generation unit generates the presentation information so that objects that are stored in the storage unit and that have a smaller degree of association with the user-specified object included in the document information than a threshold value are not presented.

2. A document management apparatus comprising:
an extraction unit configured to extract one or more parts as objects from document information;
a calculation unit configured to calculate a degree of association between objects for a plurality of objects extracted by the extraction unit;
a storage unit configured to store the plurality of objects extracted by the extraction unit and the degree of association between objects calculated by the calculation unit; and
a generation unit configured to generate presentation information in response to an operation performed by a user to specify an object included in the document information, the presentation information being for presenting objects including the user-specified object included in the document information and one or more objects that are stored in the storage unit and that have a greater or equal degree of association with the user-selected object included in the document information than or to a threshold value
wherein the generation unit is configured to generate presentation information for displaying, in a reduced form, objects whose degree of association with the user-specified object included in the document information is smaller than a threshold value.

3. The document management apparatus according to claim 2, wherein the generation unit configured such that, in response to an operation by a user to select an object displayed in a reduced form, the generation unit refers to a corresponding original object stored in the storage unit and further reproduces presentation information for presenting the original object.

4. The document management apparatus according to claim 2, wherein the calculation unit calculates the degree of association based on location information of each object in the document information.

5. The document management apparatus according to claim 2, wherein the calculation unit calculates the degree of association of each object for document information within a specified range.

6. The document management apparatus according to claim 2, wherein:
each object includes an identifier identifying the same or similar object, the identifier being set based on a part corresponding to the object;
the calculation unit calculates the degree of association between objects including different identifiers; and
in response to an operation performed by a user to specify an object included in the document information, the generation unit produces presentation information for presenting objects including the user-specified object included in the document information and one or more objects that are stored in the storage unit and that have the same identifier and have a greater degree of association with the user-selected object included in the document information than a threshold value.

7. A method comprising the steps of:
extracting one or more parts as objects from document information;
calculating a degree of association between objects for a plurality of objects extracted in the extraction step;
storing the plurality of objects extracted in the extraction step and the degree of association between objects calculated in the calculation step; and
generating presentation information in response to an operation performed by a user to specify an object included in the document information, the presentation information being for presenting objects including the user-specified object included in the document information and one or more objects that have been stored in the storing step and that have a greater or equal degree of association with the user-selected object than or to a threshold value,
wherein the presentation information is generated so that objects that have been stored in the storing step and that have a smaller degree of association with the user-specified object included in the document information than a threshold value are not presented.

8. A method comprising the steps of:
extracting one or more parts as objects from document information;
calculating a degree of association between objects for a plurality of objects extracted in the extraction step;
storing the plurality of objects extracted in the extraction step and the degree of association between objects calculated in the calculation step; and
generating presentation information in response to an operation performed by a user to specify an object included in the document information, the presentation information being for presenting objects including the user-specified object included in the document information and one or more objects that have been stored in the storing step and that have a greater or equal degree of association with the user-selected object than or to a threshold value,
wherein the generation step includes the step of generating presentation information for displaying, in a reduced form, objects that have been stored in the storing step and that have a smaller degree of association with the user-specified object included in the document information than a threshold value.

9. The method according to claim 8, wherein the generation step includes the steps of, in response to an operation by a user to select an object displayed in a reduced form, referring to a corresponding original object stored in the storing step and further reproducing presentation information for presenting the original object.

10. The method according to claim 8, wherein in the calculation step, the degree of association is calculated based on location information of each object in the document information.

11. The method according to claim 8, wherein in the calculation step, the degree of association of each object is calculated for document information within a specified range.

12. The method according to claim 8, wherein:
each object includes an identifier identifying the same or similar object, the identifier being set based on a part corresponding to the object;
in the calculation step, the degree of association between objects including different identifiers is calculated; and
in the generation step, in response to an operation performed by a user to specify an object included in the document information, presentation information is generated for presenting objects including the user-specified object included in the document information and one or more objects that have been stored in the storing step and that have the same identifier and have a greater degree of association with the user-selected object included in the document information than a threshold value.

13. A computer-readable storage medium in which a program configured to be executed by a computer to practice a method is stored, the method comprising the steps of:
extracting one or more parts as objects from document information;
calculating a degree of association between objects for a plurality of objects extracted in the extraction step;
storing the plurality of objects extracted in the extraction step and the degree of association between objects calculated in the calculation step; and
generating presentation information in response to an operation performed by a user to specify an object included in the document information, the presentation information being for presenting objects including the user-specified object included in the document information and one or more objects that have been stored in the storing step and that have a greater or equal degree of association with the user-selected object than or to a threshold value,
wherein the presentation information is generated so that objects that have been stored in the storing step and that have a smaller degree of association with the user-specified object included in the document information than a threshold value are not presented.

14. A computer-readable storage medium in which a program configured to be executed by a computer to practice a method is stored, the method comprising the steps of:
extracting one or more parts as objects from document information;
calculating a degree of association between objects for a plurality of objects extracted in the extraction step;
storing the plurality of objects extracted in the extraction step and the degree of association between objects calculated in the calculation step; and
generating presentation information in response to an operation performed by a user to specify an object included in the document information, the presentation information being for presenting objects including the user-specified object included in the document information and one or more objects that have been stored in the storing step and that have a greater or equal degree of association with the user-selected object than or to a threshold value,
wherein the generation step includes the step of generating presentation information for displaying, in a reduced form, objects that have been stored in the storing step and that have a smaller degree of association with the user-specified object included in the document information than a threshold value.
